(19) United States
(12) Patent Application Publication
(10) Pub. No.: US 2002/0119217 A1
(43) Pub. Date: Aug. 29, 2002

(54) Production for tequila

(76) Inventors: Gordon K. Whitney, Louisville, KY (US); Theodore S. Lioutas, Louisville, KY (US); Lincoln W. Henderson, Louisville, KY (US); Larry Combs, Louisville, KY (US)

Correspondence Address: MCDERMOTT, WILL & EMERY, 600 13th Street, N.W., Washington, DC, 20005-3096, US

(21) Appl. No.: 10/005,873

(22) Filed: Dec. 7, 2001

Related U.S. Application Data
(60) Provisional application No. 60/251,516, filed on Dec. 7, 2000.

(51) Int. Cl. C12C 11/00

(52) U.S. Cl. 426/11

(57) ABSTRACT

The leaves of the blue agave plant, heretofore considered as waste, are processed to produce additional tequila by a process comprising reducing the size of the leaves, mixing with water, macerating the tissue by physical force to release sugars from the leaves, and subjecting the leaves to alcohol fermentation, either alone or in combination with tequila production from the piña of the blue agave plant.

### CROSS REFERENCE TO RELATED APPLICATIONS

This invention claims priority from U.S. Provisional Application Serial No. 60/251,516, filed Dec. 7, 2000.

### FIELD OF THE INVENTION

This invention relates to improved procedures for the production of tequila from the agave plant and more particularly to procedures for processing the leaves (Pencas) of the agave plant for the production of additional tequila in conventional fermentation processes.

### BACKGROUND OF THE INVENTION

Tequila is an alcoholic drink made in the arid highlands of central Mexico from fermented and distilled sap from the agave plant and particularly the blue agave plant (Agave Tequilana Weber var. azul). This particular blue agave plant is one of 136 species of agave that grow in Mexico. Tequila is conventionally made from the roasted center (piña) of the blue agave. This part of the plant is called the heart or root and is also sometimes called the head or cabeza and which looks like a large pineapple or pine cone. This portion of the plant starts underground but soon pushes its way into the light. A mature piña may weigh 80 lbs. to more than 300 lbs.

When ready for harvesting, the carbohydrate rich pin a is cut from its stalk. Then the 200 or more spiky and thorn covered leaves (pencas) that stand out from the agave are cut away from the heart by a harvester. The piña is then used to make tequila. Conventionally, the remainder of the agave plant including the leaves have no other uses in tequila production.

U.S. Pat. No. 3,895,999 discloses a process for obtaining a crude sapogenin from agave leaves using a series of process steps. However, the agave plants referred to in this patent do not include a blue agave plant as being a source of the leaves.

The present invention provides a process by which sugars which would be available for alcohol fermentation are obtained from the blue agave plant, which heretofore have been discarded as waste.

### SUMMARY OF THE INVENTION

It is accordingly one object of the present invention to provide an improved method for the production of tequila.

A further object of the invention is to provide a method by which additional portions of the blue agave plant and particularly the leaves of the plant can be used to improve yields of tequila from the blue agave plant.

Other objects and advantages of the invention will become apparent as the description thereof proceeds.

In accordance with the present invention, improved yields of tequila from the blue agave plant are made possible by processing the leaves of the blue agave plant to make additional sugars available for alcohol fermentation, the process comprising the following steps:

a) harvesting the leaves from the blue agave plant and chopping into small pieces;

b) adding an aqueous solvent to the chopped leaves;

c) macerating the tissue in the solvent; and

d) incorporating the resulting sugars from the leaf extract for use in tequila production comprising alcohol fermentation and yeast/microbial cell growth.

### DESCRIPTION OF THE INVENTION

The first step of tequila production is harvesting of the piña—the portion of the plant resembling a pineapple that contains a reserve of inulin which is a form of starch. Harvesting involves cutting of the entire above-ground portion of the plant from the roots and subsequent removal and disposal of the pencas or leaves from the piñas.

The piñas are then cooked to hydrolyze the inulin to fermentable sugars. The sugars from the cooked piñas are then converted by fermentation by yeast to produce alcohol (ethanol). The alcohol is distilled to provide tequila. Various treatments after distillation yield the different classes of tequila (silver, gold, reposado, anejo). Sugar from a source other than the agave, such as cane sugar may be used in amounts of up to 49% (w/v) to produce mixto tequila. 100% agave tequila cannot use this added sugar.

This type of processing has been in progress for hundreds of years in Mexico. In recent years, however, the blue agave plant has become in short supply. This supply is caused by skyrocketing demand, unusual weather conditions and blights on the plant from fungi and bacteria. Accordingly there is a need to increase the production of tequila from the present resources.

The present invention provides a further source of fermentable sugars from the Agave plant. In particular, this invention is based on the discovery that the pencas or leaves contain sufficient levels of sugar for the production of additional tequila, increasing the yields from each plant by up to 10%. Therefore, the present invention provides a procedure by which the pencas or leaves may be processed to provide additional sugars from the blue agave plant to increase the overall yield of tequila from the plant and thereby extend the available supply.

In accordance with the present invention, additional sugars are made available from the agave pencas for alcohol fermentation by processing of the pencas or leaves of the blue agave plant. In this process, the pencas or leaves are initially harvested and reduced in size for processing. A convenient way to reduce the size is by simply chopping the leaves or plant material into pieces with conventional equipment. At this point, the processed leaves or plant material are then blended with water to produce an aqueous leaf extract. Preferably, each 100 g of chopped leaves is blended with about 20-100 ml of water. Preferably, the ratio of chopped leaves and water ranges from about 2:1 to 4:1.

In a preferred embodiment of the invention, this aqueous extract is then supplemented with nutrients such as sucrose, ammonium sulfate, ammonium phosphate, magnesium sulfate, inulinase or the like.

The resulting aqueous extract is then processed to macerate the tissue of the leaves contained in the aqueous medium. In laboratory procedures, a blender is suitable for this purpose but obviously in large scale production, conventional equipment would be used to beat or macerate the tissue and leaves.

The sugars are obtained directly in the water extract of the pencas, i.e., because they are water soluble. The major sugar present is actually a type of starch known as inulin. Inulin must be hydrolyzed to fermentable sugars (mainly fructose and some glucose). In normal piña processing, heat is used to break down the inulin. One may also use an enzyme (inulinase) in the lab to break down inulin to fermentable sugars.

The sugars from this pencas or leaf extract may then be used for tequila production including alcohol fermentation and yeast/microbial cell growth in conventional procedures for the production of tequila. In other alternative embodiments, the solids may or not be removed from the liquid extract prior to fermentation. Heat and/or enzymatic treatment may or not be used to hydrolyze the inulin to fermentable sugars prior to fermentation.

The following is a general procedure for the production of tequila from the piña or the heart of the blue agave plant. The sugars from the pencas extract produced according to this invention can be processed in the same manner as the heart of the blue agave plant to yield tequila, and/or the pencas extract can be added to the fermentation procedure to increase the yields of alcohol in the fermentation process.

When ready for harvesting, the carbohydrate-rich piña is cut from its stalk. Then the 200 or more 6-7 foot spiky and thorn-covered leaves (pencas) that stand out from the agave are cut away from the heart by a harvester. Some distillers “pre-cook” the piñas to rid them of external waxes and solids that may be retained in the penca which can make a bitter or unpleasant juice. The steam-injected wash autoclaves used in modern distilleries also wash away any external materials from the piñas. It takes about 7 kilograms of piña to produce 1 liter of 100% agave tequila—which means the average piña can make 60-100 liters.

Traditional distillers let the piñas soften in steam rooms or slow-bake ovens for 50-72 hours. This bakes the agave to process its natural juices at around 140-185° F. This slow-bake process softens the fibers and helps keep the agave from carmelizing, which adds darker and bitter flavors to the juice and reduces the agave sugars. Baking in ovens also helps retain more of the natural agave flavors.

Many large distillers prefer to cook their piñas faster in efficient steam autclaves and pressure cookers in as little as a single day (8-14 hours). The baking process turns the complex carbohydrates into fermentable sugars and softens the piña so they can easily release their juice. Fresh from the oven, the piñas taste a bit like a sweet potato or yam, with a mild tequila aftertase. In traditional distilleries, the piñas are allowed to cool for another 24-36 hours after steaming, then they are mashed to separate the pulp from the juice (although some traditional distillers keep them together during the fermenting).

The resulting wort is sprinkled with yeast. Traditionally this is a yeast that grows naturally on the leaves of the plant, but today it may be a cultivated form of that wild yeast or even a commercial brewer's yeast (natural fermentation from airborne yeasts is sometimes allowed in some traditional mezcals and pulque. The must (mosto) is left to ferment in wooden or stainless steel tanks. This can naturally take seven to 12 days, but modern plants add chemicals to accelerate yeast growth so fermentation results in a more robust body. Fermented must may also be used as a starter mixture for the next batch. Sometimes the must is fermented with the residual pulp with the piñas left in it to impart the most flavor to the liquid—another traditional practice—but more often the pulp is disposed of.

The result of fermentation is a liquid with about 5-7% alcohol. It is then distilled twice in traditional copper pot stills or in more modem stainless-steel column stills. Distillation takes 4-8 hours. The first distillation takes 1.5-2 hours. It is called the ordinario and is about 20% alcohol. The second distillation takes 3-4 hours. It has about 55% alcohol. It has three components: the cabeza, or head, has more alcohol and unwanted aldehydes, so it is discarded. The middle section is the El corazon, the heart, which is the best part and saved for production. The end is the colos, or tails, which is sometimes recycled into the next distillation to make it more robust, or it may also be discarded. The residue, or dregs (vinazas) is discarded.

All tequila is clear right after distillation. The color comes later, from aging in wooden barrels or from additives or wood essence. Before bottling, most tequila is filtered through activated carbon or cellulose filters.

The following example is presented to illustrate the invention but the invention is not to be considered limited thereto and its obvious variations thereon will become apparent to those skilled in the art.

### EXAMPLE

To illustrate that alcohol can be obtained using the present invention, the following laboratory procedure was carried out using leaves or pencas of the blue agave plant.

In this example, 500 g of leaves (pencas) were chopped and blended with 200 ml of water to produce 370 ml of an aqueous leaf extract. The aqueous extract was supplemented with the following nutrients:

sucrose—56 g/l

ammonium sulfate—0.75 g/l

ammonium phosphate—0.31 g/l

inulinase—0.1 ml/l

water—up to 500 ml/l

These nutrients were added to this experiment since this was a laboratory experiment designed to produce alcohol from the leaves. The inulinase was added in lieu of cooking the inulin starch to get fermentable sugars in this example. Conventionally, one would use the usual nutrients in the production of tequila in a large scale production.

Prior to the addition of nutrients, the aqueous leaf extract was macerated in a blender to free the sugars from the leaf tissue. After the nutrients were then blended with the aqueous leaf extract, two strains of commercially available dry yeast were added and the mixture was allowed to ferment at 35° C. for 2 days. After fermentation for 2 days, ethanol values were determined to be 4.4% v/v on average as determined by laboratory distillation.

The present invention as been described herein with reference to certain preferred embodiments. However as obvious variations thereon will become apparent to those skilled in the art, the invention is not to be considered as limited thereto.

What is claimed is:

1. A method to obtain alcohol from the leaves of the blue agave plant, which comprise the following steps:
a) reduce the size of the leaves from the blue agave plant;
b) add water to the leaves;
c) subject the water-leaf mixture to physical force to macerate the tissues and release sugars;
d) subject the sugars obtained from step 3 to alcohol fermentation and yeast microbial cell growth to produce alcohol.

2. A process according to claim 1 including the additional step of mixing the sugars obtained from the aqueous extract with sugars obtained from piñas in the production of tequila

3. A process according to claim 1, wherein in step a), the size of the leaves is reduced by chopping the leaves into small pieces.

4. A process according to claim 1, wherein sufficient water is added in step b) so that the ratio of chopped leaves to water ranges from about 2:1 to 4:1.

5. A process according to claim 1, wherein nutrients are added to the water.

6. A process according to claim 5, wherein the nutrients are selected from the group consisting of sucrose, ammonium sulfate, ammonium phosphate, magnesium sulfate, inulinase, and mixtures thereof.

7. A process according to claim 1, wherein maceration in step d) is carried out by adding yeast to the macerated mixture from step c), and the resulting mixture allowed to ferment for 1 to 5 days to produce ethanol.
